(19) United States
(12) Patent Application Publication
(10) Pub. No.: US 2015/0307744 A1
(43) Pub. Date: Oct. 29, 2015

(54) PRIMER RESIN COMPOSITION FOR VEHICLE REFLECTOR

(71) Applicants: HYUNDAI MOBIS CO., LTD., Seoul (KR); NOROO BEE CHEMICAL CO., LTD., Cheonan-si (KR)

(72) Inventors: Jung Hwan LEE, Yongin-si (KR); Yong CHUN, Suwon-si (KR); Jae Beom AHN, Anyang-si (KR); Young Hoon CHOI, Cheonan-si (KR); Soon Gi KIM, Cheonan-si (KR)

(21) Appl. No.: 14/695,722

(22) Filed: Apr. 24, 2015

(30) Foreign Application Priority Data
Apr. 25, 2014 (KR) 10-2014-0050166

(51) Int. Cl. C09D 183/06; B05D 7/00; F21S 8/10; B05D 7/14

(52) U.S. Cl. CPC C09D 183/06; B05D 7/14; B05D 7/56; F21S 48/1394; C08K 5/521

(57) ABSTRACT

The present invention relates to a primer resin composition for a vehicle reflector. In an embodiment, the primer resin composition for the vehicle reflector includes: (A) about 38 wt % to about 49 wt % of a silicone resin; (B) about 21 wt % to about 38 wt % of a silicone-modified polyester resin; (C) about 0.1 wt % to about 5 wt % of an adhesion promoter; and (D) about 15 wt % to about 40 wt % of a solvent.

### CROSS-REFERENCES TO RELATED APPLICATIONS

This application claims the benefit of Korean Patent Application No. 10-2014-0050166, filed on Apr. 25, 2014, in the Korean Intellectual Property Office, the entire disclosures of which are incorporated herein by reference.

### BACKGROUND

1. Field

Embodiments of the present invention relate to a primer resin composition for a vehicle reflector.

2. Description of Related Art

Generally, a vehicle is equipped with a headlamp that illuminates the front of the vehicle during running at night or in dark tunnels or foggy or rainy conditions to ensure the field of view of the driver. The vehicle's headlamp may be composed of a projection unit, disposed in a housing inside the vehicle, and an outer lens attached to the outside of the vehicle.

The headlamp may include a reflector coated with a primer coating. Japanese Patent Publication No. 1995-053723, Korean Patent Laid-Open Publication No. 2008-0094299, and Korean Patent Laid-Open Publication No. 2012-0097769 disclose the related technology.

### SUMMARY

An aspect of the present invention provides a primer resin composition for a vehicle reflector, which has excellent heat resistance, durability and weather resistance.

Another aspect of the present invention provides a primer resin composition for a vehicle reflector, which exhibits excellent deposition and adhesion properties in an aluminum deposition process.

A further aspect of the present invention provides a primer resin composition for a vehicle reflector, which has excellent light distribution, appearance and reliability properties.

A further aspect of the present invention provides a method for forming a vehicle reflector using the above-described primer resin composition for the vehicle reflector.

A further aspect of the present invention provides a vehicle reflector including a primer layer formed of the above-described primer resin composition for the vehicle reflector.

One aspect of the present invention relates to a primer resin composition for a vehicle reflector. In an embodiment, a primer resin composition for a vehicle reflector includes: (A) about 38 wt % to about 49 wt % of a silicone resin; (B) about 21 wt % to about 38 wt % of a silicone-modified polyester resin; (C) about 0.1 wt % to about 5 wt % of an adhesion promoter; and (D) about 15 wt % to about 40 wt % of a solvent.

In an embodiment, the silicone resin (A) contains about 1.5 wt % to about 5 wt % of a silanol group.

In an embodiment, the silicone-modified polyester resin (B) contains about 2 wt % to about 4 wt % of a hydroxyl group.

In an embodiment, the adhesion promoter (C) is a hydroxy phosphate ester-based or carboxyl phosphate ester-based adhesion promoter.

In an embodiment, the solvent (D) includes one or more selected from among methanol, ethanol, isopropyl alcohol, acetone, ethyl acetate and butyl acetate.

In an embodiment, the primer resin composition for the vehicle reflector further includes, based on the total weight of the composition, about 0.1 wt % to about 3 wt % of a reaction catalyst (E).

In an embodiment, the reaction catalyst (E) includes one or more selected from among zinc octoate, cobalt octanoate and dimethyl in dilaurate.

In an embodiment, the primer resin composition for the vehicle reflector further includes, based on the total weight of the composition, about 0.01 wt % to about 1 wt % of a wetting additive (F).

In an embodiment, the wetting additive (F) is a polyether-modified siloxane-based wetting additive.

In an embodiment, the silicone resin (A) and the silicone-modified polyester resin (B) are included at a weight ratio of about 1:0.4 to about 1:0.7.

Another aspect of the present invention relates to a method for forming a vehicle reflector using the primer resin composition for the vehicle reflector. In an embodiment, the method for forming the vehicle reflector includes: forming a primer layer on one surface of a metal substrate using the above-described primer resin composition for the vehicle reflector; forming an aluminum layer on the surface of the primer layer; and forming a top coat layer on the surface of the aluminum layer.

A further aspect of the present invention relates to a vehicle reflector including a primer layer formed of the above-described primer resin composition for the vehicle reflector. In an embodiment, the vehicle reflector includes: a metal substrate; a primer layer formed on one surface of the metal substrate; an aluminum layer formed on the surface of the primer layer; and a top coat layer formed on the surface of the aluminum layer, wherein the primer layer may be formed of the above-described primer resin composition for the vehicle reflector.

In an embodiment, the metal substrate includes aluminum (Al), magnesium (Mg) or an alloy thereof; the primer layer is formed to a thickness of about 5 μm to about 30 μm; the aluminum layer is formed to a thickness of about 30 nm to about 120 nm; and the top coat layer is formed to a thickness of about 0.5 μm to about 5 μm.

A vehicle component coated with a primer resin composition for a vehicle reflector according to the present invention has excellent heat resistance, durability and weather resistance, and thus a rainbow phenomenon and light loss phenomenon in the vehicle reflector may be prevented even at high temperatures (230° C. or higher). In addition, the primer resin composition for a vehicle reflector may exhibit excellent deposition, gloss and adhesion properties in a process of depositing aluminum on the vehicle reflector, and may also show excellent light distribution, appearance and reliability properties.

### BRIEF DESCRIPTION OF DRAWINGS

FIG. 1 is a schematic cross-sectional view of a general vehicle headlamp.

FIG. 2 is a schematic cross-sectional view of a vehicle reflector according to an embodiment of the present invention.

### DESCRIPTION OF EMBODIMENTS

One aspect of the present invention relates to a primer resin composition for a vehicle reflector.

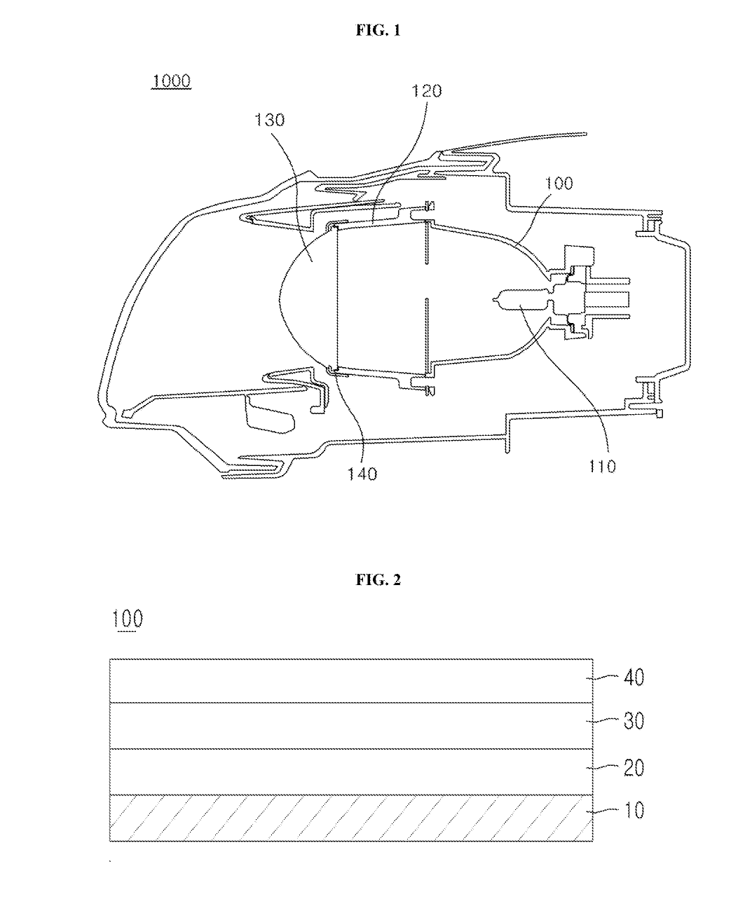

FIG. 1 is a schematic cross-sectional view of a general vehicle headlamp 1000. Referring to FIG. 1, the vehicle headlamp 1000 may include: a light-emitting unit 110 including a bulb and a socket and configured to emit light; a reflector 100 provided around the light-emitting unit 100 and configured to reflect the emitted light to thereby maximize the light distribution performance of the light-emitting unit 110; a holder 120 configured to fix the reflector 100; a lens 130 disposed in front of the reflector 100 and configured to transmit the light in a specific direction; and a rim 140 configured to fix the lens 130. In addition, the vehicle headlamp may further include a light-shading member 122 fixed to the open end of the reflector 100 and configured to prevent the scattered reflection of light emitted from the light-emitting unit 110.

This reflector 100 is generally formed by die-casting of aluminum (Al) or magnesium (Mg) so as to be able to resist the heat generated during the emission of heat from the light-emitting unit 110, and is optionally pretreated the formed material with chromate. Then, a primer is coated on the reflector for the purpose of increasing the smoothness of the light-reflecting surface of the reflector 100, and is cured by UV light or heat, after which a metal such as aluminum is deposited on the primer and coated with a base coating.

Meanwhile, when the reflector 100 is coated with a primer coating, a coating containing a silicone-based resin having excellent adhesion, heat resistance, cold resistance and weather resistance characteristics, but has a disadvantage of low mechanical strength. Thus, there is a method for preparing an organic modified silicone resin, which can maximize the characteristics of silicone resin and employ the advantages of organic resin. According to the method, the weather resistance, chemical resistance and solvent resistance of a polyester resin can be improved by introducing a silicone compound (polysiloxane) into the polyester resin. However, the reflector 100 formed using this silicone-based resin still has a problem in that a decrease in adhesion and a discoloration phenomenon, which are caused by intense heat conditions or the heat generated during the emission of light from the light-emitting unit 110, are not completely prevented.

In addition, improvement in the performance of the light-emitting unit 110 of the headlamp 1000 and environmental conditions in intense heat areas, improvement in the heat resistance of the reflector 100 before application of the light-emitting unit 110 may be tried so that the light distribution performance of the aluminum-deposited reflector 100 is not reduced even at higher temperatures.

In an example, when a polybutadiene resin-based primer layer was formed on the material (magnesium or aluminum) of the reflector 100 and an aluminum layer was formed thereon, there was a limit to increasing the heat resistance (180° C.→230° C.). In another example, the development of UV curable coatings, such as a UV curable coating comprising phenolic resin and modified alkyd resin may be provided. In a further example, a UV curable resin containing a urethane/butadiene acrylate oligomer may be provided. However, UV curing lines in Korea are insufficient, and when a UV curable primer coating is used, it is difficult to ensure a high heat resistance of 230° C. or higher.

In an embodiment, a primer resin composition for a vehicle reflector includes: (A) a silicone resin; (B) a silicone-modified polyester resin; (C) an adhesion promoter; and (D) a solvent.

More specifically, the primer resin composition for the vehicle reflector includes: (A) about 38 wt % to about 49 wt % of a silicone resin; (B) about 21 wt % to about 38 wt % of a silicone-modified polyester resin; (C) about 0.1 wt % to about 5 wt % of an adhesion promoter; and (D) about 15 wt % to about 40 wt % of a solvent.

Hereinafter, the primer resin composition for the vehicle reflector according to embodiments of the present invention will be described.

(A) Silicone Resin

The silicone resin (A) is included in the composition in order to ensure heat resistance, adhesion to a metal substrate, gloss, and appearance characteristics such as smoothness (leveling).

In an embodiment, the silicone resin (A) may include a structure represented by the following formula 1:

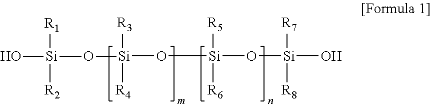

wherein R₁, R₂, R₃, R₄, R₅, R₆, R₇ and R₈ are each independently an alkyl group or an aryl group; m is an integer ranging from 1 to 100; and n is an integer ranging from 1 to 100.

In an embodiment, R₁, R₂, R₄, R₅, R₆, R₇ and R₈ may be an alkyl group, and R₃ may be an aryl group. More specifically, R₁, R₂ and R₄ to R₈ may be a methyl group, and R₃ may be a phenyl group. In this case, the primer resin composition according to embodiments of the present invention may have excellent thermal stability and heat resistance, and may also have excellent adhesion to a metal substrate.

In an embodiment, the silicone resin (A) may have a weight-average molecular weight of about 2,000 g/mol to about 7,000 g/mol. Within this range, the primer resin composition according to embodiments of the present invention may have excellent heat resistance and excellent adhesion to a metal substrate.

In an embodiment, the silicone resin (A) may contain about 1.5 wt % to about 5 wt % of a silanol group. Within this range, the primer resin composition according to embodiments of the present invention may be easily cured in a primer layer formation process as described below, and thus a primer layer having excellent heat resistance, adhesion, smoothness and appearance characteristics may be formed. For example, the silicone resin (A) may contain about 2 wt % to about 4 wt % of a silanol group.

In an embodiment, the silicone resin (A) may have a silicon dioxide (SiO₂) content of about 45 wt % to about 75 wt %. In this content range, a primer layer as described below may have high curing density (surface density) and heat resistance.

In an embodiment, the silicone resin (A) may contain a methyl group and a phenyl group at a weight ratio of about 1:0.2 to about 1:0.6. In this range, the primer resin composition according to embodiments of the present invention may have excellent thermal stability, hardness, water repellency, chemical resistance, heat resistance and mechanical strength.

In an embodiment, the silicone resin (A) is included in an amount of about 38 wt % to about 49 wt % based on the total weight of the primer resin composition for the vehicle reflector. In this range, the composition has excellent adhesion to a metal substrate and excellent gloss and smoothness. If the composition includes less than about 38 wt % of the silicone resin (A), the heat resistance, adhesion to a metal substrate, gloss and smoothness of the composition can be reduced, and if the composition includes more than about 49 wt % of the silicone resin (B), the sagging of the primer layer will occur at a drying temperature of 200° C. or lower in a primer layer formation process as described below, thereby reducing the appearance thereof. For example, the silicone resin (A) may be included in an amount of about 40 wt % to about 47 wt %. For example, it may be included in an amount of about 42 wt % to about 45 wt %. In an embodiment, it may be included in an amount of about 38, 39, 40, 41, 42, 43, 44, 45, 46, 47, 48 or 49 wt %.

(B) Silicone-Modified Polyester Resin

The silicone-modified polyester resin (B) is included in the composition for the purpose of ensuring appearance, heat resistance, processability, solvent resistance, chemical resistance and weather resistance properties.

The silicone-modified polyester resin (B) that is used in embodiments of the present invention may be prepared by a conventional method. For example, it may be a polyester resin containing a silicone intermediate or a silicone resin. For example, it may be prepared using the method disclosed in Korean Patent Registration No. 0417087.

For example, the silicone-modified polyester resin (B) may be prepared by reacting glycol having a divalent or higher valent reactive hydroxyl group with an organic acid or organic acid derivative having a divalent or higher valent carboxyl acid group to prepare a polyester polyol having a number-average molecular weight of about 1000 g/mol or less and a reactive hydroxyl value of about 100 mgKOH/g or more, polymerizing the hydroxyl group of the polyester polyol with a silicone intermediate having hydroxyl group or alkoxy group to prepare a silicone-modified polyester resin, and then polymerizing a silane having two or more alkoxy groups with the resin.

Examples of the glycol having a divalent or higher valent reactive hydroxyl group, which is used in embodiments of the present invention, include ethylene glycol, propylene glycol, 1,4-butylene glycol, 1,6-haxanediol, neopentyl glycol, 1,4-cyclohexanediol, 2-butyl-2-ethylpentanediol, trimethylolpropane, trimethylolethane, trihydroxy isocyanurate, glycerin and pentaerythritol. These may be used alone or a mixture of two or more, but are not limited thereto.

Examples of the organic acid or organic acid derivative having a divalent or higher valent reactive carboxyl group, which is used in embodiments of the present invention, include terephthalic acid and its derivatives, isophthalic acid and its derivatives, phthalic anhydride and its derives, succinic acid, adipic acid, azelaic acid and trimellitic anhydride. These may be used alone or in a mixture of two or more, but are not limited thereto.

In an embodiment, the self-curable silicone-modified polyester resin (B) may be prepared by copolymerizing a polyester polyol having a number average molecular weight of about 100 g/mol to about 1,000 g/mol and a reactive hydroxyl value of about 100 mgKOH/g or higher with a silicone intermediate having a hydroxyl group content of about 2 wt % to about 10 wt % to prepare a prepolymer having a silicone content of about 20 wt % to about 80 wt %, and then polymerizing a silane having two or more alkoxy groups with the prepolymer at an equivalent ratio of about 0.5 to about 2 to the hydroxyl equivalent of the prepolymer.

In an embodiment, in order to promote the reaction between the polyester polyol and the silicone intermediate, a catalyst comprising a titanium-based compound (i.e., titanium alkoxide), a titanium chelate compound or an aluminum chelate compound may be used. In an embodiment, tetraisopropyl titanate or tetrabutyl titanate may be used.

When the silicone-modified polyester resin (B) is prepared as described above, it may have high storage stability at room temperature, and may also have high heat resistance at high temperatures (250° C. to 400° C.), as well as excellent weather resistance and mechanical strength.

The silicone-modified polyester resin (B) may contain about 2 wt % to about 4 wt % of a hydroxyl group. Within this range, a coat layer will be easily formed in a primer layer formation process as described below, and may have excellent heat resistance and mechanical properties. For example, the silicone-modified polyester resin (B) may contain a hydroxyl group in an amount of about 2, 2,5, 3, 3.5 or 4 wt %.

The silicone-modified polyester resin (B) may have a weight-average molecular weight ranging from about 3,000 g/mol to about 9,000 g/mol. Within this range, the composition of embodiments of the present invention may have excellent heat resistance and high adhesion to a metal substrate.

The silicone-modified polyester resin (B) is included in an amount of about 21 wt % to about 38 wt % based on the total weight of the primer resin composition for the vehicle reflector. Within this range, it is possible to ensure the appearance, heat resistance, processability, solvent resistance, chemical resistance and weather resistance characteristics of the composition of embodiments of the present invention. If the silicone-modified polyester resin (B) is included in an amount of less than about 21 wt %, the sagging of the primer coat layer may occur to reduce the appearance thereof, and if the silicone-modified polyester resin (B) is included in an amount of more than about 38 wt %, the hardness of the coat layer may be reduced, and thus a rainbow phenomenon on the surface of the coat layer may occur. For example, it may be included in an amount of about 23 wt % to about 32 wt %. For example, it may be included in an amount of about 26 wt % to about 30 wt %. In an embodiment, it may be included in an amount of about 21, 22, 23, 24, 25, 26, 27, 28, 29, 30, 31, 32, 33, 34, 35, 36, 37 or 38 wt %.

In an embodiment of the present invention, the silicone resin (A) and the silicone-modified polyester resin (B) may be included at a weight ratio ranging from about 1:0.4 to about 1:0.7. In this range, the composition may have excellent compatibility and appearance, and may ensure heat resistance, thereby preventing a rainbow phenomenon and a light loss phenomenon on an aluminum layer as described below.

(C) Adhesion Promoter

The adhesion promoter (C) is included in the primer resin composition for the purpose of increasing the adhesion of the primer layer to an aluminum layer and a metal substrate. In an embodiment, the adhesion promoter (C) may be a phosphate ester-based adhesion promoter. More specifically, it may be a hydroxy phosphate ester-based or carboxyl phosphate ester-based adhesion promoter. When this kind of adhesion promoter (C) is used, it can increase the chemical bonding of the composition to a metal substrate, thereby increasing the adhesion of the composition to an aluminum layer and a metal substrate as described below. Commercial products for the adhesion promoter (C), which may be used in embodiments of the present invention, include, but are not limited to, Lubrizol® 2063 (Lubrizol).

In an embodiment, the adhesion promoter (C) is included in an amount of about 0.1 wt % to about 5 wt % based on the total weight of the primer resin composition for the vehicle reflector. If the adhesion promoter (C) is included in an amount of less than about 0.1 wt %, the effect of improving the adhesion and water resistance of the composition will be insufficient, and if the adhesion promoter (C) is included in an amount of more than about 5 wt %, the viscosity of the composition will excessively increase to reduce the workability thereof, and a turbid phenomenon or a seeding phenomenon will occur and a haze phenomenon on the coat layer will occur in a primer layer formation process. For example, the adhesion promoter (C) may be included in an amount of about 0.1 wt % to about 3 wt %. For example, it may be included in an amount of about 0.1 wt % to about 1 wt %. In an embodiment, it may be included in an amount of about 0.1, 0.2, 0.3, 0.4, 0.5, 0.6, 0.7, 0.8, 0.9, 1, 1.5, 2, 2.5, 3, 3.5, 4, 4.5 or 5 wt %.

(D) Solvent

The solvent (D) is included in the composition of embodiments of the present invention for the purpose of ensuring the dispersibility of the composition and the smoothness and appearance properties of the coat layer while controlling the viscosity of the composition to increase the workability of the composition in a primer layer formation process.

Examples of the solvent (D) that is used in embodiments of the present invention include methanol, ethanol, isopropyl alcohol, acetone, ethyl acetate and butyl acetate. These may be used alone or in a mixture of two or more.

In an embodiment, the solvent (D) may comprise butyl acetate and isopropyl alcohol at a weight ratio of about 1:0.5 to about 1:1.5. When the solvent (D) is used as described above, the viscosity and volatilization rate of the solvent (D) in a primer layer formation process as described below can be easily controlled to increase the workability of the composition, and the smoothness and appearance characteristics of the coat layer can be easily ensured.

In an embodiment, the solvent (D) is included in an amount of about 15 wt % to about 40 wt % based on the total weight of the primer resin composition for the vehicle reflector. If the solvent (D) is included in an amount of less than about 15 wt %, the workability of the composition of embodiments of the present invention will be reduced, and if the solvent (D) is included in an amount of more than about 40 wt %, the heat resistance and appearance characteristics of the primer resin composition for the vehicle reflector can be reduced. For example, it may be included in an amount of about 20 wt % to about 35 wt %. For example, it may be included in an amount of about 25 wt % to about 32 wt %. In an embodiment, it may be included in an amount of about 15, 16, 17, 18, 19, 20, 21, 22, 23, 24, 25, 26, 27, 28, 29, 30, 31, 32, 33, 34, 35, 36, 37, 38, 39 or 40 wt %.

(E) Reaction Catalyst

The primer resin composition for the vehicle reflector according to embodiments of the present invention may further include a reaction catalyst (E) functioning as a condensation reaction catalyst that reduces the curing temperature and curing time in a primer layer formation process as described below. When the reaction catalyst (E) is included in the composition, it may function as a catalyst that enables curing to be performed at a temperature (230° C.) lower than the condensation reaction temperature of silanol (250° C. or higher).

In embodiments of the present invention, the reaction catalyst (E) may be one or more selected from among zinc octoate, cobalt octanoate and dimethyl in dilaurate. When this kind of reaction catalyst (E) is used, crosslinking and coat layer curing by the easy condensation of the silanol group of the silicone resin (A) can be achieved at lower temperatures.

In an embodiment, the reaction catalyst (E) may be included in an amount of about 0.1 wt % to about 3 wt % based on the total weight of the primer resin composition for the vehicle reflector. Within this range, the reaction catalyst (E) may have excellent effects of promoting silanol condensation and reducing the curing temperature and curing time. For example, the reaction catalyst (E) may be included in an amount of about 0.1 wt % to about 2 wt. For example, it may be included in an amount of about 0.5 wt % to about 1.5 wt %. In an embodiment, it may be included in an amount of about 0.1, 0.2, 0.3, 0.4, 0.5, 1, 1.5, 2, 2.5 or 3 wt %.

(F) Wetting Additive

The primer resin composition for the vehicle reflector according to embodiments of the present invention may further include a wetting additive (F) that is generally used in embodiments of the present invention. The wetting additive (F) may be included in the composition for the purpose of reducing the surface tension and increasing the wettability of the composition to impart compatibility, slippage and leveling properties to the composition.

In embodiments of the present invention, the wetting additive (F) may be a polyether-modified siloxane-based wetting additive. When this kind of wetting additive (F) is used, it may have excellent wetting and leveling properties.

In an embodiment, the wetting additive (F) may be included in an amount of about 0.01 wt % to about 1 wt % based on the total weight of the primer resin composition for the vehicle reflector. If it is included in an amount in this range, it may increase the compatibility of the composition and the wetting and leveling properties of the coat layer without reducing the adhesion of the coat layer to an aluminum layer as described below. For example, the wetting additive (F) may be included in an amount of about 0.05 wt % to about 0.5 wt %. For example, it may be included in an amount of about 0.1 wt % to about 0.5 wt %. In an embodiment, it may be included in an amount of about 0.01, 0.1, 0.2, 0.3, 0.4, 0.5, 0.6, 0.7, 0.8, 0.9 or 1 wt %.

Another aspect of the present invention relates to a method for forming a vehicle reflector using the primer resin composition for the vehicle reflector. In an embodiment, the method for forming the vehicle reflector may include the steps of: (a) preparing a metal substrate; (b) forming a primer layer; (c) forming an aluminum layer; and (d) forming a top coat layer. Specifically, the method may include: forming a primer layer on one surface of a metal substrate using the above-described primer resin composition for the vehicle reflector; forming an aluminum layer on the surface of the primer layer; and forming a top coat layer on the surface of the aluminum layer.

(a) Step of Preparing Metal Substrate

This step (a) is a step of preparing a metal substrate. The metal substrate may be made of aluminum, magnesium or an alloy thereof. In an embodiment, the metal substrate may be prepared by a die-casting process using aluminum, magnesium or an alloy thereof. When the metal substrate is prepared by a die-casting process using this material, it may have excellent lightweight and appearance properties, can be prepared in large amounts within a short time, and may have excellent heat resistance against the heat generated by the emission of light from the light-emitting unit 110, and excellent durability.

In an embodiment, the method may further include, after the step of preparing the metal substrate by die casting, a step of treating the surface of the metal substrate. In an embodiment, the surface treatment may be performed by polishing the surface of the metal substrate by a sand blast method. In an embodiment, the surface of the metal substrate may be polished using the sand blast method at a temperature between about 180° C. and about 250° C. for about 20 minutes to about 100 minutes. When the surface of the metal substrate is treated by this method, the surface non-uniformity of the metal substrate, which occurs during die casting, can be prevented, and foreign matter generated during die casting can be removed, thereby increasing the appearance, corrosion resistance, light distribution, adhesion and deposition properties of a primer layer and aluminum layer formed as described below.

(b) Step of Forming Primer Layer

This step (b) is a step of forming a primer layer on one surface of the metal substrate using the above-described primer resin composition for the vehicle reflector. In an embodiment, the primer layer may be formed to a thickness of about 5 μm to about 30 μm. When it is formed to this thickness, an aluminum layer as described below will be easily formed, and the adhesion, appearance, durability, heat resistance and moisture resistance of the primer layer of embodiments of the present invention can be ensured. For example, the primer layer may be formed to a thickness of about 10 μm to about 25 μm.

In an embodiment, the primer layer may be formed by applying the primer resin composition to one surface of the metal substrate, and curing the applied composition. In an embodiment, the curing may be performed at a temperature between about 200° C. and about 250° C. for about 20 minutes to about 50 minutes. Under such curing conditions, a condensation reaction between the silanol group of the silicone resin (A) and the silanol group of the silicone-modified polyester resin in the primer resin composition for the vehicle reflector will occur to crosslink the resins, and thus a primer layer having excellent heat resistance can be easily formed.

(c) Step of Forming Aluminum Layer

This step (c) is a step of forming an aluminum layer on the surface of the aluminum layer formed as described above. In embodiments of the present invention, the aluminum layer may be formed by vacuum-depositing aluminum using a conventional aluminum deposition system.

Specifically, the aluminum layer may be deposited on the surface of the primer layer by placing the primer layer-formed metal substrate in an aluminum deposition system, injecting oxygen or nitrogen gas into the deposition system, and performing sputtering or ion plating using aluminum as a target material under a pressure of about 1.0×10⁻³ torr to about 1.0×10⁻⁵ torr. When the aluminum layer is formed by the above-described method, it may have a uniform and dense structure.

In an embodiment, the aluminum layer may be formed to a thickness ranging from about 30 nm to about 120 nm. Within this range, the vehicle reflector of embodiments of the present invention may have excellent corrosion resistance, appearance, light distribution, durability, heat resistance and moisture resistance and will be excellent in economic terms. For example, the aluminum layer may be formed to a thickness of about 50 nm to about 100 nm.

(d) Step of Forming Top Coat Layer

This step (d) is a step of forming a top coat layer on the surface of the aluminum layer. The top coat layer may be formed for the purpose of preventing the surface of the formed aluminum layer from being oxidized by a reaction with atmospheric impurities.

The top coat layer may be formed of a conventional material that is used in the vehicle reflector field. In an embodiment, it may be formed using hexamethyldisiloxane (HMDSO) as a precursor. The top coat layer may be formed by a conventional method. For example, it may be formed by a physical vapor deposition (PVD) or chemical vapor deposition (CVD) method.

When the top coat layer is formed on the aluminum layer using hexamethyldisiloxane as described above, it may comprise an SiO₂ component having excellent stability.

In an embodiment, the top coat layer may be formed to a thickness ranging from about 0.5 μm to about 5 μm. In this thickness range, the vehicle reflector of embodiments of the present invention will be excellent in economic terms while having excellent corrosion resistance, appearance, light distribution, heat resistance and moisture resistance properties. For example, the top coat layer may be formed to a thickness of about 0.5 μm to about 5 μm.

Still another aspect of the present invention relates to a vehicle reflector including a primer layer formed of the above-described primer resin composition for the vehicle reflector.

FIG. 2 is a schematic cross-sectional view of a vehicle reflector 100 according to an embodiment of the present invention. Referring to FIG. 2, the vehicle reflector 100 according to an embodiment of the present invention includes: a metal substrate 10; a primer layer 20 formed on one surface of the metal substrate 10; an aluminum layer 30 formed on the surface of the primer layer 20; and a top coat layer 40 formed on the surface of the aluminum layer 30, wherein the primer layer 20 is formed applying and curing the above-described primer resin composition for the vehicle reflector.

In an embodiment, the metal substrate 10 may include aluminum (Al), magnesium (Mg) or an alloy thereof.

In an embodiment, the primer layer 20 may be formed to a thickness ranging of about 5 μm to about 30 μm. Within this thickness range, the primer layer may have excellent adhesion to the aluminum layer 30 and the metal substrate 10, and the reflector 100 may have excellent corrosion resistance, heat resistance and durability, so that a rainbow phenomenon, an orange peel phenomenon and the like on the reflector 100 can be prevented. For example, the primer layer 20 may be formed to a thickness of about 10 μm to about 25 μm.

In an embodiment, the aluminum layer 30 may be formed to a thickness ranging from about 30 nm to about 120 nm. Within this thickness range, the vehicle reflector may have excellent heat resistance, corrosion resistance, durability, gloss, appearance and light distribution properties. For example, the aluminum layer 30 may be formed to a thickness of about 50 nm to about 100 nm.

In an embodiment, the top coat layer 40 may be formed to a thickness ranging from about 0.5 μm to about 5 μm. Within this thickness range, the vehicle reflector of embodiments of the present invention may have weather resistance and durability, and thus can be prevented from yellowing. For example, the top coat layer 40 may be formed to a thickness of about 0.5 μm to about 5 μm.

The reflector 100 including the primer layer formed of the primer resin composition of embodiments of the present invention may have excellent heat resistance, durability and weather resistance, thus preventing a rainbow phenomenon and a light loss phenomenon thereon even at high temperatures (230° C. or higher). In addition, the vehicle reflector may have excellent deposition, gloss and adhesion properties, and thus peeling of the layer from the vehicle reflector will not occur even under intense heat conditions. In addition, it may have excellent light distribution, appearance and reliability characteristics.

Hereinafter, the present invention will be described in further detail with reference to examples. It is to be understood, however, that these examples are provided for a better understanding of the present invention and are not intended to limit the scope of the present invention. Contents that are not disclosed herein can be sufficiently understood by any person skilled in the art, and thus the description thereof is omitted.

### Examples 1 and 2 and Comparative Examples 1 to 7

In Examples 1 and 2 and Comparative Examples 1 to 7, the following components (A) to (F) were prepared and mixed to have the contents shown in Table 1 below, thereby preparing primer resin compositions.

(A) Silicone Resin

A silicone resin (804 resin, Dow Corning) having a weight-average molecular weight of 2,000 g/mol to 7,000 g/mol, a weight ratio of methyl to phenyl of 1:0.4, a silanol group content of 3 wt % and an SiO₂ content of 64 wt % was used.

(B) Silicone-Modified Polyester Resin

100 parts by weight of trimethylolpropane (TMP) was reacted with 70 parts by weight of isophthalic acid (IPA) to prepare a polyester polyol resin having a weight-average molecular weight of 490 g/mol and a reactive hydroxyl value of 490 mgKOH/g. Then, 770 g of the polyester polyol resin solution and 500 g of silicone intermediate Z-6018 (Dow Corning) having a silanol content of 5.5 wt % were placed in a four-neck flask and heated, and when the content in the flask was melted, 1 part by weight of tetrabutyl titanate was added thereto and completely dispersed by high-speed stirring. Then, the content in the flask continued to be heated to 100° C.˜200° C. while the reaction effluent was slowly removed. When the reaction effluent reached the theoretical amount (22.5 g), the reaction product sample was placed on a glass plate and cooled to room temperature. When the reaction product sample reached a transparent state, the reaction product was cooled, 380 g of a xylene solvent was added thereto to reach a resin solid content of 60%, thereby preparing a silicone-modified polyester resin having a weight-average molecular weight of 8,000 g/mol and a hydroxyl group content of 2 wt % to 4 wt %.

(C) Adhesion Promoter

A carboxyl phosphate ester-based adhesion promoter (Lubrizol@ 2063, Lubrizol) was used.

(D) Solvent

A 1:1 mixture of butyl acetate and isopropyl alcohol was used.

(E) Reaction Promoter

Zn-octoate was used.

(F) Wetting Additive

Polyether-modified polydimethylsiloxane (BYK-306®, BYK) was used.

TABLE 1

| Com- | | | | | | | | | |
|---|---|---|---|---|---|---|---|---|---|
| po- | Examples | | Comparative Examples | | | | | | |
| nents | 1 | 2 | 1 | 2 | 3 | 4 | 5 | 6 | 7 |
| (A) | 42 | 40 | 51 | 45 | 42 | 40 | 49 | 34 | 34 |
| (B) | 29 | 30 | 26 | 18 | 30 | 22 | 38 | 30 | 40 |
| (C) | 0.1 | 0.1 | 0.1 | 0.1 | 7 | 0.01 | 0.1 | 0.1 | 0.1 |
| (D) | 28.7 | 29.7 | 22.7 | 36.7 | 20.8 | 37.79 | 12.7 | 35.7 | 25.7 |
| (E) | 0.1 | 0.1 | 0.1 | 0.1 | 0.1 | 0.1 | 0.1 | 0.1 | 0.1 |
| (F) | 0.1 | 0.1 | 0.1 | 0.1 | 0.1 | 0.1 | 0.1 | 0.1 | 0.1 |
| Total | 100 | 100 | 100 | 100 | 100 | 100 | 100 | 100 | 100 |

(Unit: wt %)

A metal substrate for a vehicle reflector was prepared by an aluminum die-casting process, and the surface of the metal substrate was treated by a sand blast process at 200° C. for 60 minutes.

Each of the primer resin compositions of Examples 1 and 2 and Comparative Examples 1 to 7 was applied to the surface-treated metal substrate, and then cured by hot-air drying at 230° C. for 30 minutes, thereby forming a primer layer having a thickness of 25 μm.

Aluminum was deposited on the surface of the formed primer layer using an aluminum deposition system (PylonMet, LEYBOLD) to form an aluminum layer having a thickness of 80 nm.

A top coat layer having a thickness of 1.5 μm was formed on the surface of the formed aluminum layer using hexamethyldisiloxane (HMDSO), thereby manufacturing a vehicle reflector.

Test Example

For Examples 1 and 2 and Comparative Examples 1 to 7, the following properties were measured, and the results of the measurement are shown in Table 2 below.

(1) Appearance

For Examples 1 and 2 and Comparative Examples 1 to 7, whether the surface had visible defects, including surface swelling, discoloration, reduced gloss, sagging, scratches, and orange peel, was measured, and the results of the measurement are shown in Table 2 below.

(2) Adhesion

Adhesion was evaluated by performing a cross-cut tape test in accordance with ASTM D3359.

(3) Moisture Resistance

Each test sample was allowed to stand at a temperature of 50±2° C. and a relative humidity of 98±2% for 240 hours, and then allowed to stand at room temperature for 1 hour. Next, whether the sample had remarkable discoloration, fading, swelling, cracking, reduced gloss and abnormal adhesion was evaluated.

(4) Water Resistance

For Examples 1 and 2 and Comparative Examples 1 to 7, each test sample was immersed in tap water at a temperature of 40° C. for 24 hours, and then taken out and dried by air blowing to remove water from the surface. Next, each test sample was allowed to stand at room temperature for 1 hour, and then whether the aluminum layer formed in each of Examples 1 and 2 and Comparative Examples 1 to 7 had remarkable discoloration, fading, swelling, cracking, reduced gloss and abnormal adhesion was evaluated.

(5) Heat Resistance

Each test sample was allowed to stand at a temperature of 230±2° C. for 72 hours, and then allowed to stand at room temperature for 1 hour. Next, whether the aluminum layer formed in each of Examples 1 and 2 and Comparative Examples 1 to 7 had remarkable discoloration, fading, swelling, cracking, reduced gloss and abnormal adhesion was evaluated.

(6) Chemical Resistance

Each test sample was dipped in 1% sulfuric acid solution, 1% sodium hydroxide solution and 3% sodium chloride solution for 10 minutes, and then washed with water. Next, whether the aluminum layer formed in each of Examples 1 and 2 and Comparative Examples 1 to 7 had remarkable discoloration, fading, swelling, cracking, reduced gloss and abnormal adhesion was evaluated.

(7) Cooling-Heating Cycle Test

Each test sample was allowed to stand at a temperature of 80±2° C. at a relative humidity of 95% for 4 hours, and then allowed to stand at a temperature of −40±2° C. and at a relative humidity of 95% for 4 hours, and this process of allowing the test sample to stand was repeated 10 times. Next, each test sample was allowed to stand at room temperature for 1 hour, and then whether the aluminum layer formed in each of Examples 1 and 2 and Comparative Examples 1 to 7 had remarkable discoloration, fading, swelling, cracking, reduced gloss and abnormal adhesion was evaluated.

TABLE 2

| | Example | | Comparative Example | | | | | | |
|---|---|---|---|---|---|---|---|---|---|
| | 1 | 2 | 1 | 2 | 3 | 4 | 5 | 6 | 7 |
| Appearance | Good | Good | Poor | Poor | Poor | Poor | Poor | Good | Good |
| | | | (occurrence | (occurrence | (occurrence | | | | |
| | | | of sagging) | of sagging) | of seeding) | | | | |
| Adhesion | 100/100 | 100/ | 87/ | 88/ | 93/ | 59/ | 82/ | 89/ | 86/ |
| | | 100 | 100 | 100 | 100 | 100 | 100 | 100 | 100 |
| Moisture | Good | Good | Good | Good | Good | Good | Good | Good | Good |
| resistance | | | | | | | | | |
| Water | Good | Good | Good | Good | Poor | Poor | Poor | Poor | Poor |
| resistance | | | | | | | | | |
| Heat | Good | Good | Poor | Poor | Good | Poor | Poor | Poor | Poor |
| resistance | | | | | | | | | |
| Chemical | Good | Good | Good | Good | Poor | Poor | Good | Poor | Good |
| resistance | | | | | | | | | |
| Cooling- | Good | Good | Good | Good | Poor | Poor | Poor | Poor | Poor |
| heating cycle | | | | | | | | | |
| test | | | | | | | | | |

As can be seen in Table 2, in the case of Comparative Examples 1 to 7, which did not contain the components of the embodiments of the present invention or were out of the content ranges specified in embodiments of the present invention, physical properties such as heat resistance, tensile strength and weather resistance or reliability were reduced compared to those of Examples 1 to 2. In particular, it could be seen that, in the case of Comparative Examples 1 to 7, sagging and seeding phenomena on the surface occurred to deteriorate the appearance.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A primer resin composition for a vehicle headlamp reflector, the composition comprising:
(A) about 38 wt % to about 49 wt % of a silicone resin;
(B) about 21 wt % to about 38 wt % of a silicone-modified polyester resin;
(C) about 0.1 wt % to about 5 wt % of an adhesion promoter; and
(D) about 15 wt % to about 40 wt % of a solvent.

2. The primer resin composition according to claim 1, wherein the silicone resin (A) contains about 1.5 wt % to about 5 wt % of a silanol group.

3. The primer resin composition according to claim 1, wherein the silicone-modified polyester resin (B) contains about 2 wt % to about 4 wt % of a hydroxyl group.

4. The primer resin composition according to claim 1, wherein the adhesion promoter (C) is a hydroxy phosphate ester-based or carboxyl phosphate ester-based adhesion promoter.

5. The primer resin composition according to claim 1, wherein the solvent (D) comprises one or more selected from among methanol, ethanol, isopropyl alcohol, acetone, ethyl acetate and butyl acetate.

6. The primer resin composition according to claim 1, further comprising, based on the total weight of the primer resin composition, about 0.1 wt % to about 3 wt % of a reaction catalyst (E).

7. The primer resin composition according to claim 6, wherein the reaction catalyst (E) comprises one or more selected from among zinc octoate, cobalt octanoate and dimethyl in dilaurate.

8. The primer resin composition according to claim 1, further comprising, based on the total weight of the primer resin composition, about 0.01 wt % to about 1 wt % of a wetting additive (F).

9. The primer resin composition according to claim 8, wherein the wetting additive (F) is a polyether-modified siloxane-based wetting additive.

10. The primer resin composition according to claim 1, wherein the silicone resin (A) and the silicone-modified polyester resin (B) are included at a weight ratio ranging from about 1:0.4 to about 1:0.7.

11. A method for forming a vehicle headlamp reflector, comprising:
forming a primer layer on one surface of a metal substrate using the primer resin composition of claim 1;
forming an aluminum layer on the surface of the primer layer; and
forming a top coat layer on the surface of the aluminum layer.

12. A vehicle reflector comprising:
a metal substrate;
a primer layer formed on one surface of the metal substrate;
an aluminum layer formed on the surface of the primer layer; and
a top coat layer formed on the surface of the aluminum layer,
wherein the primer layer is formed of the primer resin composition of claim 1.

13. The vehicle reflector according to claim 12, wherein the metal substrate comprises aluminum (Al), magnesium (Mg) or an alloy thereof;
the primer layer is formed to a thickness of about 5 μm to about 30 μm;
the aluminum layer is formed to a thickness of about 30 nm to about 120 nm; and
the top coat layer is formed to a thickness of about 0.5 μm to about 5 μm.
